(19) United States
(12) Patent Application Publication
(10) Pub. No.: US 2009/0325047 A1
(43) Pub. Date: Dec. 31, 2009

(54) BATTERY COVER MECHANISM

(75) Inventors: Yu Zhang, Shenzhen City (CN); Shui-Jin Dong, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/422,357

(22) Filed: Apr. 13, 2009

(30) Foreign Application Priority Data
Jun. 26, 2008 (CN) 200810302340.4

(51) Int. Cl. H01M 2/10

(52) U.S. Cl. 429/96

(57) ABSTRACT

A battery cover mechanism used in a portable electronic device includes a housing defining a receiving groove therein for receiving a battery, an elastic member mounted on the housing and a cover corresponding to the housing. The elastic member is releasably held by the cover such that the cover can be mounted on the housing for covering the receiving groove, and the cover can be detached from the housing when the elastic member is released from the cover.

### BACKGROUND

1. Field of the Invention

The present invention relates to battery cover mechanisms, particularly to a battery cover mechanism used in portable electronic devices.

2. Description of Related Art

Portable electronic devices such as mobile phones and personal digital assistants (PDA) are widely used. Changeable batteries are installed in most portable electronic devices to supply electric power. When a battery is installed in a portable electronic device, it is generally shielded and fixed in place by a battery cover mechanism, thus the battery and the inner circuits of the portable electronic device are well protected.

A conventional battery cover mechanism generally includes a cover and a housing. The cover tightly engages with the housing to be secured thereon. However, due to the tight engagement of the cover and the housing in many conventional designs, a significant amount of impact and friction exist between the cover and the housing. As a result, the user may need to apply a significant amount of strength to assemble/disassemble the cover to/from the housing. Further, the cover and the housing may be distorted or even damaged by impact or friction between each other in the assembly/disassembly operation.

Therefore, there is room for improvement within the art.

### BRIEF DESCRIPTION OF THE DRAWINGS

Many aspects of the present battery cover mechanism can be better understood with reference to the following drawings. The components in the various drawings are not necessarily drawn to scale, the emphasis instead being placed upon clearly illustrating the principles of the present battery cover mechanism. Moreover, in the drawings, like reference numerals designate corresponding parts throughout the diagrams.

FIG. 1 is a disassembled view of a battery cover mechanism, according to an exemplary embodiment.

FIG. 2 is a disassembled view of the battery cover mechanism shown in FIG. 1, but shown in another view angle.

FIG. 3 is an assembled view of the battery cover mechanism shown in FIG. 1.

FIG. 4 is a cutaway view along the line IV-IV shown in FIG. 3.

### DETAILED DESCRIPTION OF THE EMBODIMENT

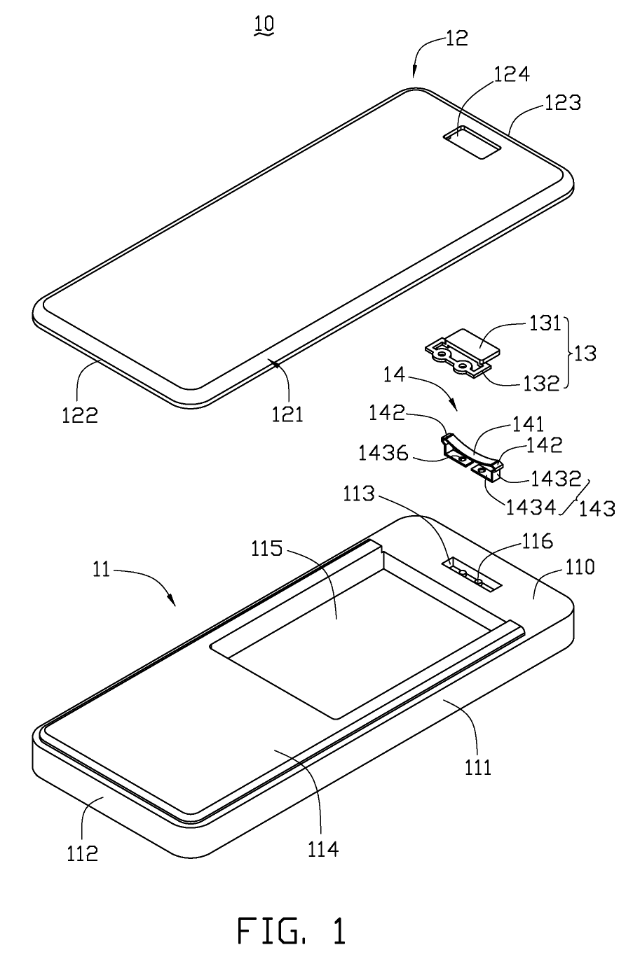

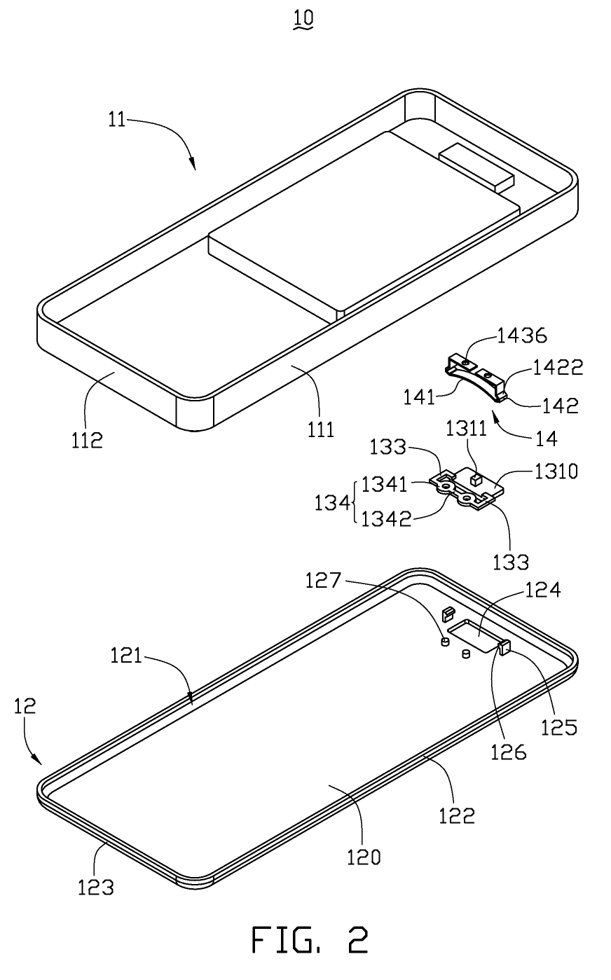

FIGS. 1 and 2 show a battery cover mechanism 10 according to an exemplary embodiment. While the exemplary battery cover mechanism 10 is used in a mobile phone, it can also be used in other portable electronic devices, such as a personal digital assistant (PDA), a digital camera, etc. The battery cover mechanism 10 includes a housing 11, a cover 12, an operating member 13 and an elastic member 14.

The housing 11 can be a part of the housing of a portable electronic device. The housing 11 is approximately rectangular shaped and includes a planar assembling surface 110, two opposite side walls 111 defined on two relative long sides of the housing 11 and two opposite end walls 112 defined on two relative short sides of the housing 11. The side walls 111 and the end walls 112 form a frame (not labeled) surrounding a surface (not labeled) of the housing 11 opposite to the assembling surface 110.

A part of the assembling surface 110, which is adjacent to one of the end walls 112, recesses to form an approximately rectangular fixing recess 113. Two fixing pins 116 are formed on a bottom surface of the fixing recess 113 and extend upwardly towards the assembling surface 110. Another part of the assembling surface 110 protrudes to form a convex assembling portion 114. Apart of the assembling portion 114 recesses to form a receiving groove 115 for receiving a battery (not shown).

The cover 12 is an approximately rectangular panel corresponding to the housing 11. The cover 12 has a planar mounting surface 120, and a side frame 121 perpendicularly formed on a peripheral portion of the mounting surface 120 to surround the mounting surface 120. The inner portion of the side frame 121 is configured to correspond to the outer portion of the assembling portion 114, thus the side frame 121 can engage with the assembling portion 114 such that the cover 12 is assembled to the housing 11 to cover the battery in the receiving groove 15. The side frame 121 includes two opposite side walls 122 defined on two relative long sides of the cover 12 and two opposite end walls 123 defined on two relative short sides of the cover 12.

The cover 12 defines a rectangular operating hole 124 adjacent to one of the end walls 122 therein. The position of the operating hole 124 corresponds to that of the fixing recess 113. Two holding hooks 125 and two assembling poles 127 are formed on the mounting surface 120. The holding hooks 125 are respectively disposed adjacent to two opposite sides of the operating hole 124 parallel to the side walls 122. Each holding hook 125 extends perpendicularly from the mounting surface 120 and has a perpendicularly bent end 126. The two ends 126 extend parallel to the mounting surface 120 and toward each other. The assembling poles 127 are formed adjacent to a side of the operating hole 124 parallel to the end wall 123, such that the operating hole 124 is disposed between each assembling pole 127 and the end wall 123.

The operating member 13 includes an operating component 131 and a resilient component 132. The operating component 131 includes a rectangular pushing board 1310 corresponding to the operating hole 124 and a protrusion 1311 formed on a central portion of the pushing board 1310. The resilient component 132 includes two approximately U-shaped resilient arms 133 and a fixing component 134 connected between the two resilient arms 133. The fixing component 134 includes two fixing loops 1341 corresponding to the assembling poles 127 and a connecting portion 1342 connected between the two fixing loops 1341. The two resilient arms 133 are respectively connected to two fixing loops 1341, wherein each resilient arm 133 has an end connected to a corresponding fixing loop 1341 and another end connected to the pushing board 1310. The resilient arms 133, the fixing loops 134 and the connecting portion 1342 are all positioned on a same plane parallel to the pushing board 1310.

The elastic member 14 includes an elastic portion 141, two holding portions 142 and two fixing portions 143. The elastic portion 141 is a bent arc-shaped sheet. Two ends of the elastic portion 141 respectively bend against each other and then retrace to extend towards each other, thereby forming two holding portions 142 protruding outwardly, and each holding portion 142 has a holding surface 1422 corresponding to the insides of the holding hooks 125. The fixing portions 143 are L-shaped sheets respectively connected to the two holding portions 142, wherein each fixing portion 143 has a connecting sheet 1432 connected to an end of a holding portion and a fixing sheet 1434 perpendicularly connected to the connecting sheet 1432. The widths of the connecting sheets 1432 and the fixing sheets 1434 correspond to that of the fixing recess 113, and the lengths of the connecting sheets 1432 are larger than the depth of the fixing recess 113. The two fixing sheets 1434 are disposed to be coplanar and extend towards each other. Each fixing sheet 1434 defines a fixing hole 1436 corresponding to the fixing pins 116 therein. Further, the elastic member 14 can be made by means of bending a whole elastic sheet, such as a metal sheet.

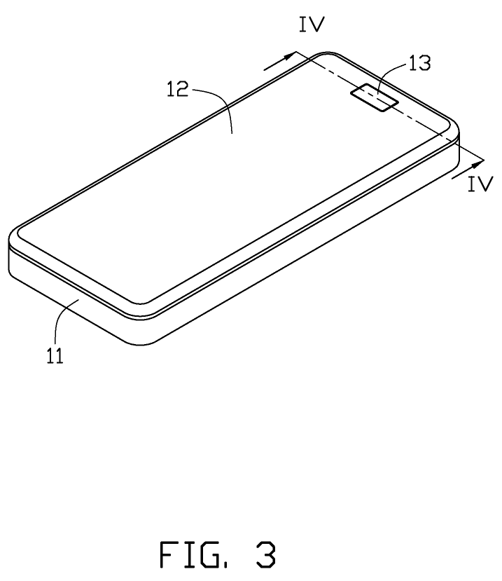

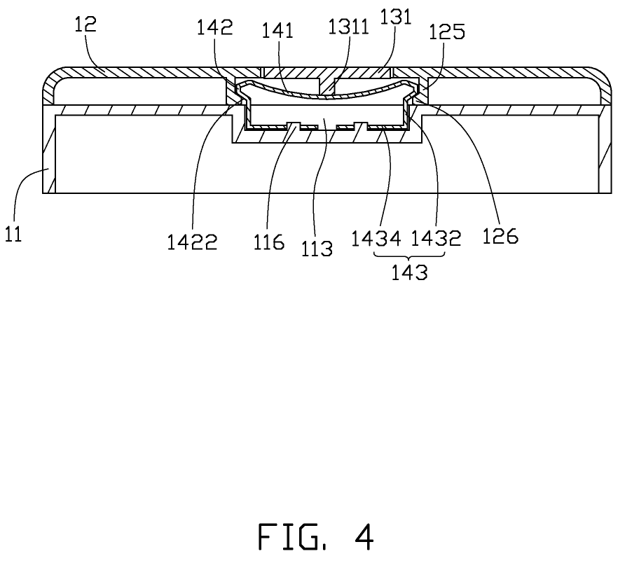

Also referring to FIG. 3 and FIG. 4, in assembly, the fixing portions 143 of the elastic member 14 are received in the fixing recess 113. The two fixing pins 116 are respectively inserted into the two fixing holes 1436, and the fixing sheets 1434 are secured in the fixing recess 113 via gluing or soldering. The connecting sheets 1432 are disposed perpendicularly to the bottom of the fixing recess 113. Since the lengths of the connecting sheets 1432 are larger than the depth of the fixing recess 113, the holding portions 142 expose out of the fixing recess 113. Thus, the elastic member 14 is mounted on the housing 11. The pushing board 1310 is received in the operating hole 124, wherein the protrusion 1311 is positioned to protrude from the mounting surface 120. The two fixing pins 127 are respectively inserted into the two fixing loops 1341 and secured in the fixing loops 1341 by gluing or soldering, thus the pushing member 13 is mounted on the cover 12. Another surface of the pushing board 1310 opposite to the protrusion 1311 is exposed out of the outer surface (i.e., the surface opposite to the assembling surface 120) of the cover 12 from the operating hole 124.

The mounting surface 120 of the cover 12 is then positioned towards the assembling surface 110 of the housing 11. Since the position of the operating hole 124 corresponds to that of the fixing recess 113, the elastic member 14 is positioned between the two holding hooks 125, and the protrusion 1131 aligns with the middle of the elastic portion 141. Afterwards, the cover 12 is pushed towards the housing 11. The holding hooks 125 press the two protruding holding portions 142 towards a middle of the elastic portion 141, then the elastic portion 141 is bent and the two holding portions 142 are driven to move towards each other. Thus, the distance between the two holding portions 142 decreases, such that the two holding portions 142 are both inserted between the two holding hooks 125. After the holding portions 142 are inserted into the holding hooks 125, the pressure under the cover 11 is removed, and the elastic portion 141 rebounds to push the two holding portions 142 respectively towards the insides of the two holding hooks 125. Thus, the distance between the two holding portions 142 is increased until the holding portions 142 are held by the holding hooks 125 and engage with the insides of holding hooks 125 using the holding surfaces 1422, and then the elastic member 14 is held between the two holding hooks 125. Finally, the side frame 121 is engaged with the assembling portion 114, and then the cover 12 is secured on the housing 11.

When the cover 12 needs to be detached from the housing 11, the exposed surface of the pushing board 1310 is pressed. The resilient arms 133 are bent such that the pushing board 1310 is pushed towards the housing 11, and the elastic portion 141 is pressed towards the housing 11 by the protrusion 1311. As the elastic portion 141 is bent, the holding portions 142 connected to two ends of the elastic portion 141 are pulled to move towards each other, and is released from the holding hooks 125 engaging therewith. Thus, the cover 12 can be detached from the housing 11. When the pressure under the pushing board 1310 is removed, the resilient arms 133 can rebound to drive the pushing board 1310 return to the operating hole 124, and the cover 12 can be assembled to the housing 11 again, with the above-mentioned method. Additionally, the connecting sheets 1432 can also be directly secured on the housing 11 (e.g., in the fixing recess 113), correspondingly, the fixing sheets 1434 can be omitted.

In the exemplary battery cover mechanism 10, the cover 12 is installed on the housing 11 through the elastic member 14, and can be detached from the housing 11 by operating the operating member 13. The cover 12 and the housing 11 need not directly tightly engage with each other, thus minimized the impact or friction generated between the cover 12 and the housing 11 in assembly and disassembly operations. Therefore, the cover 12 and the housing 11 can be well protected.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A battery cover mechanism used in a portable electronic device, comprising:
a housing defining a receiving groove therein for receiving a battery;
an elastic member mounted on the housing;
a cover corresponding to the housing, wherein the elastic member is releasably held by the cover such that the cover can be mounted on the housing for covering the receiving groove, and the cover can be detached from the housing when the elastic member is released from the cover.

2. The battery cover mechanism as claimed in claim 1, wherein the elastic member includes two fixing portions fixed on the housing, two holding portions respectively connected to the two fixed portions and releasably held by the cover, and an elastic portion connected between the two holding portions.

3. The battery cover mechanism as claimed in claim 2, wherein the housing defines a fixing recess for receiving and fixing the fixing portions therein, and the holding portions expose out of the fixing recess.

4. The battery cover mechanism as claimed in claim 2, wherein the cover includes two holding hooks corresponding to the holding portions formed thereon for releasably holding the holding portions.

5. The battery cover mechanism as claimed in claim 4, wherein the holding portions are released from the holding hooks when the elastic portion is pressed.

6. The battery cover mechanism as claimed in claim 5, further comprising an operating member mounted on the cover for being operated to release the holding portions from the holding hooks.

7. The battery cover mechanism as claimed in claim 6, wherein the operating member includes a pushing board and two resilient arms connected to the pushing board, the cover defining an operating hole receiving the pushing board therein, and the resilient arms are mounted on the cover.

8. The battery cover mechanism as claimed in claim 7, wherein the operating member further includes a protrusion formed on the pushing board and disposed to align with the elastic portion for pressing the elastic portion towards the housing when the pushing board is pressed.

9. A battery cover mechanism, comprising:
a housing defining a receiving groove therein for receiving a battery;
an elastic member mounted on the housing and including two holding portions each protruding outwards;
a cover covering the receiving groove and including two holding hooks holding the holding portions; and
an operating member mounted on the cover and aligning with the elastic member, wherein the holding portions are released from the holding hooks when the elastic member is bent by operating the operating member, such that the cover is detached from the housing.

10. The battery cover mechanism as claimed in claim 9, wherein the elastic member further includes two fixing portions fixed on the housing and respectively connected to the two holding portions and an elastic portion connected between the two holding portions.

11. The battery cover mechanism as claimed in claim 10, wherein the housing defines a fixing recess for receiving and fixing the fixing portions therein, and the holding portions expose out of the fixing recess.

12. The battery cover mechanism as claimed in claim 10, wherein the holding portions are released from the holding hooks when the elastic portion is pressed towards the housing to be bent.

13. The battery cover mechanism as claimed in claim 9, wherein the operating member includes a pushing board and two resilient arms connected to the pushing board, the cover defining an operating hole receiving the pushing board therein, and the resilient arms are mounted on the cover.

14. The battery cover mechanism as claimed in claim 13, wherein the operating member further includes a protrusion formed on the pushing board and disposed to align with the elastic portion for pressing the elastic portion towards the housing when the pushing board is pressed.
